(19) United States
(12) Patent Application Publication
(10) Pub. No.: US 2017/0051832 A1
(43) Pub. Date: Feb. 23, 2017

(54) SEAL ASSEMBLY FOR A COMPONENT SUPPORTED ROTATABLY IN RELATION TO A FURTHER COMPONENT, AND METHOD

(71) Applicants: AKTIEBOLAGET SKF, Goteborg (SE); SKF BLOHM + VOSS INDUSTRIES GMBH, Hamburg (DE)

(72) Inventors: Michael Baumann, Aberdeenshire (GB); Pascal Ehret, IJsselstein (NL); Pascal Mandou, Jassans-Riottier (FR); Lars Ziemen, Hamburg (DE)

(73) Assignees: Aktiebolaget SKF, Goteborg (SE); SKF Marine GmbH, Hamburg (DE)

(21) Appl. No.: 15/307,060

(22) PCT Filed: May 5, 2015
(86) PCT No.: PCT/EP2015/059835

§ 371 Date: Oct. 27, 2016

(30) Foreign Application Priority Data
May 6, 2014 (EP) 14305663.8

(51) Int. Cl. F16J 15/3284; F16J 15/3204

(52) U.S. Cl. CPC F16J 15/3284; F16J 15/3204

(57) ABSTRACT

A seal assembly for a component supported rotatably in relation to a further component includes a bellows, a fixed seal element, and a rotatable seal element supported in sliding contact with the fixed seal element, and the bellows is configured to generate a pressure force causing a seal effect between the fixed seal element and the rotatable seal element.

### CROSS REFERENCE TO RELATED APPLICATIONS

This is a United States National Stage Application claiming the benefit of International Application Number PCT/EP2015/059835 filed on May 5, 2015 which claims the benefit of European Patent Application 14305663.8 filed on May 6, 2014, both of which are incorporated herein by reference in their entireties.

### FIELD OF THE INVENTION

The present exemplary embodiments are in the field of seal assemblies for a component supported rotatably in relation to a further component.

### BACKGROUND OF THE INVENTION

Seals are used in many areas of technology, in particular in the field of hydropower. Here the seals can be subjected to a strong pressure at water depths of 10 s of, up to 100, meters, and correspondingly strong environmental influences. Such seals can in some cases be very complex to produce, and correspondingly cost-intensive, whereby, for example, in underwater power plants a ratio of costs to benefits can turn out unnecessarily high. Alternatively conventional solutions can indeed turn out more cost-effective, but bring along here a lower wear resistance and a higher maintenance effort. As a result thereof, under certain circumstances maintenance processes can arise unnecessarily often, which cause additional logistical complexity with underwater applications off the mainland, and can be accompanied by a danger to personnel or material by forces of nature.

### BRIEF SUMMARY OF THE INVENTION

It is therefore desirable to effect an improved compromise of seal effect, manufacturing complexity, and wear resistance in a seal assembly.

A seal device for a component supported rotatably in relation to a further component and a method for sealing in a component supported rotatably in relation to a further component according to the independent patent claims take these requirements into account.

According to a first aspect, exemplary embodiments relate to a seal assembly for a component supported rotatably in relation to a further component. The seal assembly provides a bellows, a fixed seal element, and a rotatable seal element supported in sliding contact with respect to the fixed seal element. Here a pressure force is generated by the bellows, causing a seal effect between the fixed seal element and the rotatable seal element. A manufacturing effort and thus connected costs could thereby be able to be reduced. Maintenance processes could also be less frequently required, whereby a maintenance effort and a logistical effort can be reduced.

In some exemplary embodiments a material of the fixed seal element and a material of the rotatable seal element have different degrees of hardness. A seal effect could thereby be increased. Occurring wear could be reduced in a targeted manner on a predetermined component and thus be better controllable.

In some exemplary embodiments the bellows is manufactured completely from plastic. Here a use of metallic components such as, for example, springs, can be omitted. under certain circumstances. A risk of wear by corrosion can thus possibly be avoided.

In some exemplary embodiments the bellows has a convex curvature pointing toward a volume to be sealed. It can thereby be possible to generate an additional pressure force on the rotatable seal element via the fixed seal element by a pressure difference between a medium lying on the primary side of the bellows and a volume lying on a secondary side of the bellows facing away from the primary side. A seal effect could thereby be further improved. Furthermore, depending on a pressure of the medium, the seal effect could thereby at least partially depend on a self-regulating process.

In some exemplary embodiments, volumes to be sealed are connected to a pressure chamber by the fixed seal element and the rotatable seal element. An effective total force on the seal assembly could thus be reduced and wear thereby avoided. Furthermore, excess lubricant can also be led away in this manner.

In some exemplary embodiments a material of the bellows, of the fixed seal element, or of the rotatable seal element provides polyurethane. This could effect a higher stiffness, better seal effect by stronger contact pressure, or improved wear resistance.

In some exemplary embodiments the pressure force generated by the bellows acts parallel to an axis of rotation of the rotatable seal element. A direction of application of the pressure force could thus be individually adapted to a use purpose, and installation space under certain circumstances be more effectively usable.

In some exemplary embodiments the rotatable seal element or the fixed seal element provides at least one at least part-ring-shaped element. An exchange, e.g., in the context of an initial installation or maintenance, can thereby be significantly reduced.

Some exemplary embodiments further relate to a current power plant or tidal power plant with a seal assembly for a component supported rotatably in relation to a further component. Sensitive electronics, such as are used, for example, in underwater power plants, could thus be better protected.

According to a further aspect exemplary embodiments relate to a method for sealing in a component supported rotatably in relation to a further component. The method provides a supporting of a fixed seal element with respect to a rotatable seal element in sliding contact. In addition, the method provides a generating of a pressure force by a bellows, the pressure force causing a seal effect between the fixed seal element and the rotatable seal element. A saving of corrosion-prone materials, a higher wear resistance, or an improved seal effect could thus be effected.

### BRIEF DESCRIPTION OF THE SEVERAL VIEWS OF THE DRAWING

Further advantageous designs are described in more detail below with reference to exemplary embodiments depicted in the Figures, but are not limited to the exemplary embodiments.

FIG. 1 shows in detail a cross-sectional view of a seal assembly according to a simple exemplary embodiment;

FIG. 2 shows in detail a cross-sectional view of a seal assembly according to a detailed exemplary embodiment;

FIG. 3 shows in detail a flow diagram of a method for sealing in a component supported rotatably in relation to a further component according to an exemplary embodiment.

### DETAILED DESCRIPTION OF THE INVENTION

In the following description of the accompanying Figures, like reference numbers refer to like or comparable components. Furthermore, summarizing reference numbers are used for components and objects that appear multiple times in an exemplary embodiment or in an illustration, but that are described together in terms of one or more common features. Components or objects that are described with the same or summarizing reference numbers can be embodied identically, but also optionally differently, in terms of individual, multiple, or all features, their dimensions, for example, as long as the description does not explicitly or implicitly indicate otherwise.

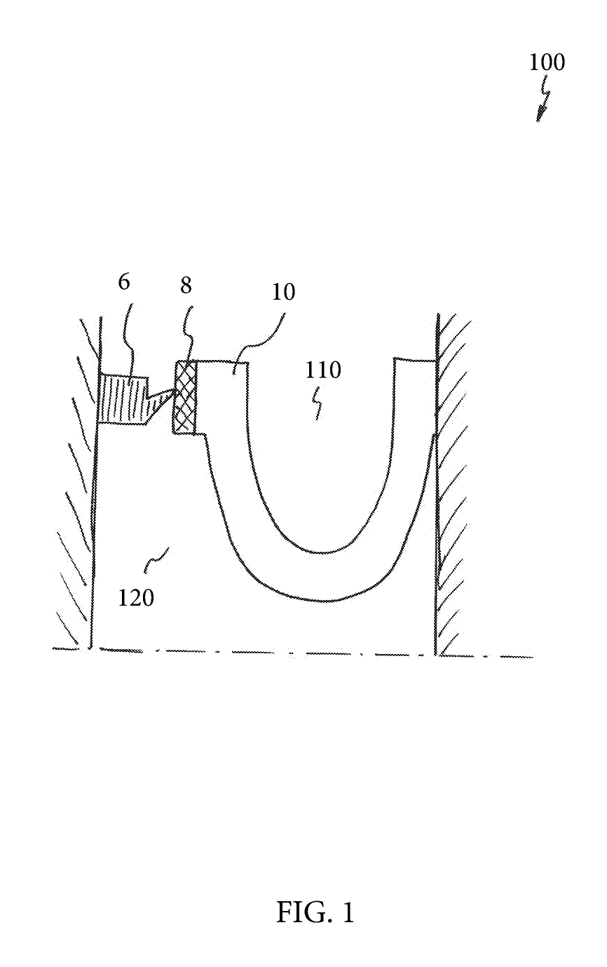

FIG. 1 shows a simple exemplary embodiment of a seal assembly 100 for a component supported rotatably in relation to a further component. The seal assembly 100 provides a bellows 10. In addition, the seal assembly 100 provides a fixed seal element 8 and a seal element 6 supported rotatably with respect to the fixed seal element in sliding contact. A pressure force, which causes a seal effect between the fixed seal element 8 and the rotatable seal element 6, is caused here by the bellows 10.

A seal effect or a sealing occurs with respect to a medium 110 surrounding the seal assembly 100. The medium 110 can be water, for example, fresh- or salt-water. In the following the terms “primary-side” or “primary side” refer to a side facing the medium 110, and correspondingly “secondary-side” or “secondary side” a side facing away from the medium 110. In other words, the medium 110 is disposed on the primary side, and a to-be-sealed volume 120 on the secondary side.

The rotatably supported component can, for example, provide a turbine or a shaft or be connected to such a turbine or shaft. The further component can be fixed and provide, for example, a housing. The rotatably supported seal element 6 or the fixed seal element 8 can include a seal lip. The seal lip can form a contact surface to the respective other seal lip. A material of the fixed seal element 8 and a material of the rotatable seal element 6 can have different degrees of hardness here. A material of the fixed seal element 8 can provide rubber, and a material of the rotatable seal element 6 polyurethane. Here polyurethane (PU) can be a plastic (such as, e.g., an elastomer) or synthetic resin, which is manufacturable from a polyaddition reaction of dialcohols (diols) or polyols with polyisocyanates. Here polyurethane can include a urethane group (—NH—CO—O—) in its molecular structure. Here a seal lip located on the rotatable seal element 6 can push-in into the fixed seal element 8. In another exemplary embodiment the fixed seal element 8 is manufactured from polyurethane and the rotatable seal element 6 from rubber, for example, hydrated acrylonitrile butadiene rubber (HNBR). Here the fixed seal element 8 can include a seal lip.

The material of the fixed seal element 8 or of the rotatable seal element 6 can further also include a polyurethane-containing elastomer, such as, for example, Ecopur. A rotational speed of the seal elements with respect to each other can fall at up to 20 or 25 rotations per minute, or even more. In comparison to conventional materials a use of polyurethane could thereby effect a higher resistance with respect to abrasion, a higher tear resistance, a higher stiffness, or also an improved extensibility.

The rotatable seal element 6 or the fixed seal element 8 can further include composite materials, nitrile-butadiene-rubber-containing materials (NPR), or also stainless steel. Optionally a coating, for example a chromium-carbide coating, can be applied onto the sealing element. In addition, the seal elements can be configured in the shape of O-rings, or also be self-lubricating, for example by distribution during operation of water used as lubricant.

A material of the bellows 10 can provide, for example, the plastic polyurethane. A high wear resistance and an improved stiffness can thereby be achieved. A use of metallic and thus possibly corrosion-prone materials in the bellows 10 can thus be omitted under certain circumstances. The bellows 10 in FIG. 1 is under tension, i.e., is compressed, e.g., by a factor smaller than 1/10, in the axial direction with respect to its rest state. A pressure force thereby arises, which can be further improved by a higher rigidity. The pressure force ensures a pressing of the fixed seal element 8 onto the rotatable seal element 6, and thus enhances its sealing effect. Here the axial direction refers to an axis of rotation of the rotatable seal element 6. A pressure force between the rotatable seal element 6 and the fixed seal element 8 can be, for example, 1-3 bar.

In one exemplary embodiment the bellows 10 is manufactured completely from plastic. A use of corrosion-prone materials for exerting a pressure force generating the sealing effect, e.g., a spring, could thus be omitted. Wear risks due to corrosion and an associated decrease of the sealing effect could thus be avoided.

On a secondary side of the seal assembly 100 a volume 120 is located, which is sealed with respect to a medium 110 located on the primary side. The bellows 10 has a convex curvature pointing toward the to-be-sealed volume 120. An additional pressure force or a pressure increase can thus be generated via the fixed seal element 8 on rotatable seal element 6 by a pressure difference between the medium 110 and the volume 120. In other words, the medium 110 can generate a force directed against the compression of the bellows 10. The pressure increase due to the medium 110 at least partially surrounding the bellows 10 can depend on an immersion depth of the seal assembly 100, and can turn out correspondingly higher due to greater depths. Here a pressure of the medium 110 can be, for example, up to 10 or 15 bar, or even more. The seal effect can thereby be additionally improved. In addition, it could thereby be made possible that the seal effect also increases with an increase of a pressure of the medium 110. In other words, in one exemplary embodiment a self-regulating sealing process takes place within predefined limit values.

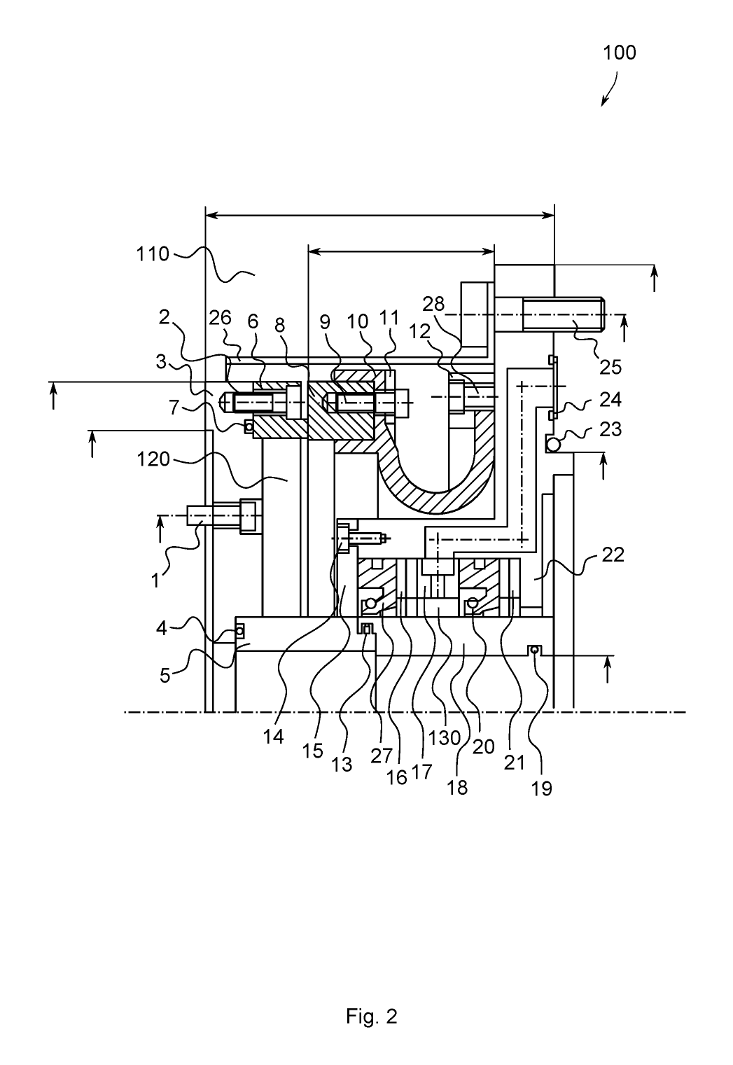

FIG. 2 shows a seal assembly 100 according to a further detailed exemplary embodiment. Herein identical or comparable components bear identical reference numbers as in FIG. 1 and are not described again in the following. Rather, only the differences are discussed. For example, in FIG. 2 the rotatable component 3 is depicted as a flange, and the fixed component 22 as a housing. The bellows 10 is attached via a screw 28 to the housing 28, and via a screw 9 to the fixed seal element 8. Optionally a washer 11 can be disposed on the screw 9 and a washer 12 on the screw 28. A better transmission of holding forces of the screws 9; 11 to the bellows 10 could thereby be made possible. Furthermore, the rotatable seal element 6 is connected via a screw 2, and optionally via an additional connecting means 7, to the rotatable component. In addition, the rotatable component 3 can include a screw 1, using which a further component (e.g., a turbine) can be attached to the rotatable component 3. The rotatable component 3 is attached to a shaft 5 via a connecting means 4.

On the primary side of the seal assembly 100, the primary side comprising the medium 110, a cover 26 is attached to the housing 22 using a screw 25. The cover 26 here extends in the axial direction. Contaminations, for example, by coarser dirt particles, in particular a penetrating thereof into the volume 120, can additionally be avoided due to the cover 26.

On the secondary side of the seal assembly 100 a further volume 130 is delimited from the volume 120 by a first spring-reinforced seal ring 27. Furthermore, the further volume 130 is bounded by a second spring-reinforced seal ring 20. The spring-reinforced seal rings 20; 27 here are supported against the housing 22 by spacers. An inlet bore 17 is furthermore disposed between the spacer 16 and the second spring-reinforced seal ring 20. If wear on the seal elements 6; 8 arises in the course of operation of the seal assembly 100, then the medium 110 can penetrate into the volume 120. The spring-reinforced seal rings 20; 27 here can effect an additional protection of components disposed secondary-side with respect to the spring-reinforced seal ring 20 or electrical components located there.

The shaft 5 is connected to a shank 18 via a connecting means 13. The shank 18 is located in sliding contact with the spring-reinforced seal rings 20; 27, and can be manufactured from a different material than the shaft 5, or include a coating made from a different material. The coating can provide, for example, polytetrafluoroethylene (PTFE). Wear can thereby possibly be reduced. If wear nevertheless occurs, for example, on the first spring-reinforced seal ring 27, then the medium 110 can penetrate into the further volume 130. A cover 15 located in the volume 120, connected using a screw 14 to the housing 22, can thereby prevent or at least reduce a penetration of coarse dirt particles. The further volume 130 can be connected to a system for remedying a leakage (English: leakage recovery system) via the inlet bore 17. Such a system can be configured, for example, to detect a penetration of moisture using a moisture sensor, and to notify an operator to the presence of a leakage by providing of a signal. Wear on the seal assembly 100 can thus be detected and a maintenance process prepared and carried out. Furthermore, the system can be configured, for example using a pump assembly, to at least partially pump out the medium 110 penetrated into the further volume 130. Under certain circumstances even with arisen wear and penetration of moisture this could reduce a possible damage on moisture-sensitive components.

The screws 1; 2; 9; 14; 25; 28 shown in FIG. 2 as well as the connecting means 4; 7; 13; 19; 23; 24 are as such only to be understood as exemplary. In principle, instead of these, other attachment means can also be used for a connecting of components. The connection here can be friction-fit, material-bonded, or interference-fit. Attachment means can therefore also provide, for example, bolts, grooves, welding seams, plug connections, adhesives, or rivets. An attachment means (e.g. screw or another attachment means) can be available for connecting a plurality of predetermined components multiple times. A plurality of identical attachment means can, for example, be disposed at identical angular intervals to one another along a circular curve about the axis of rotation.

In a further exemplary embodiment the rotatable or fixed seal element 6; 8 provides at least one part-ring-shaped element. For example, the seal element 6; 8 can be assemblable from two elements, which each follow a circular arc of 180°, or three elements, which each follow a circular arc of 120°. The provided elements can further also be differently sized and simply follow a circular arc of 360° in sum. In exemplary embodiments the seal elements here can have circular radii of up to 600 mm or 800 mm, or even greater than 800 mm.

In a still further exemplary embodiment the volume 120 sealed by the fixed seal element 8 and the rotatable seal element 6 is connected to a pressure chamber. A pressure difference, and thus a force acting by the medium 110 on the seal elements 6; 8 can thereby be reduced, whereby wear can be reduced. It can also thereby be possible to lead excess lubricant out of the volume 120.

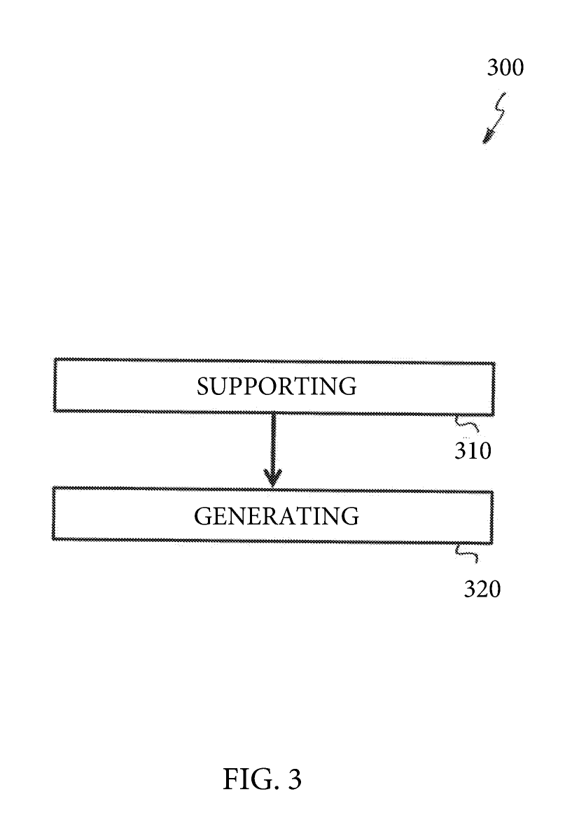

FIG. 3 shows a flow diagram of a method 300 for sealing in a component supported rotatably in relation to a further component according to an exemplary embodiment. The method 300 provides a supporting 310 of a fixed seal element with respect to a rotatable seal element in sliding contact. In addition, the method 300 provides a generating 320 of a pressure force by a bellows, the pressure force causing a seal effect between the fixed seal element and the rotatable seal element.

Exemplary embodiments can allow use at greater immersion depths compared with conventional solutions. Due to a use of polyurethane in the bellows, the fixed or the rotatable seal element a higher stiffness can be achieved in comparison to conventional elastomers, whereby the seal assembly can maintain a sealing effect to a greater environmental pressure, for example, at least 2, 5 or 15 bar.

Some of the exemplary embodiments mentioned can be used in underwater power plants, e.g., in current- or tidal-power plants. By some exemplary embodiments it can be possible to simplify a maintenance process or to provide a redundancy in a sealing whereby a possible damage can be delayed or prevented. Furthermore, under certain circumstances installation space or production costs can be saved. Additional risks, e.g., by corrosion of metallic components, can be avoided by a use of plastic. In other words, it can be possible to achieve a higher reliability or loadability of the seal assembly. Thus by exemplary embodiments maintenance processes can be simplified or accelerated, and a service life or cost efficiency can be improved.

The features disclosed in the foregoing description, the following claims, and the accompanying Figures can be meaningful and can be implemented both individually as well as in any combination for the realization of an exemplary embodiment in its various designs.

### REFERENCE NUMBER LIST

1 Screw

2 Screw

3 Rotatable component

4 Connecting means

5 Shaft

6 Rotatable seal element

7 Connecting means

8 Fixed seal element

9 Screw

10 Bellows made from plastic

11 Washer

12 Washer

13 Connecting means

14 Screw

15 Cover

16 Spacer

17 Inlet bore

18 Shank

19 Connecting means

20 Second spring-reinforced seal ring

21 Spacer

22 Fixed component

23 Connecting means

24 Connecting means

25 Screw

26 Cover

27 First spring-reinforced seal ring

28 Screw

100 Seal assembly

110 Medium

120 Volume

130 Further volume

300 Method

310 Supporting

320 Generating

1. A seal assembly for a component supported rotatably in relation to a further component, comprising a bellows, a fixed seal element, and a rotatable seal element supported in sliding contact with the fixed seal element, wherein the bellows is configured to generate a pressure force causing a seal effect between the fixed seal element and the rotatable seal element.

2. The seal assembly according to claim 1, wherein a material of the fixed seal element has a first degree of hardness and a material of the rotatable seal element has a second degree of hardness different than the first degree of hardness.

3. The seal assembly according to claim 1, wherein the bellows is manufactured completely from plastic.

4. The seal assembly according to claim 1, wherein the bellows has a convex curvature in a direction of a to-be-sealed volume.

5. The seal assembly according to claim 1, wherein a volume sealed by the fixed seal element and by the rotatable seal element is connected to a pressure chamber.

6. The seal assembly according to claim 1, wherein the bellows, or the fixed seal element, or the rotatable seal element comprises polyurethane.

7. The seal assembly according to claim 1, wherein the pressure force generated by the bellows acts parallel to an axis of rotation of the rotatable seal element.

8. The seal assembly according to claim 1, wherein the rotatable seal element or the fixed seal element comprises at least one at least part-ring-shaped element.

9. A current power plant or tidal power plant with a seal assembly according to claim 1.

10. A method for sealing in a component supported rotatably in relation to a further component, the method comprising:
supporting a fixed seal element with respect to a rotatable seal element in sliding contact; and
generating pressure force, causing a seal effect between the fixed seal element and the rotatable seal element, by a bellows.

11. The seal assembly according to claim 1,
wherein a material of the fixed seal element has a first degree of hardness and a material of the rotatable seal element has a second degree of hardness different than the first degree of hardness,
wherein the bellows is manufactured completely from plastic,
wherein the bellows has a convex curvature in a direction of a to-be-sealed volume,
wherein the bellows or the fixed seal element or the rotatable seal element comprises polyurethane, and
wherein the pressure force generated by the bellows acts parallel to an axis of rotation of the rotatable seal element.

12. The seal assembly according to claim 1, wherein the bellows comprises an annular channel having a U-shaped cross section, a radially inner wall portion having a first end and a radially outer wall portion having a second end and a rest configuration in which the first end is spaced from the second end by a first distance.

13. The seal assembly according to claim 12, wherein the bellows is elastic and wherein the bellows is compressed from the rest configuration such that the first end is spaced from the second end by a second distance less than the first distance.

14. A rotary assembly comprising the component, the further component and the seal according to claim 12.

15. A rotary assembly comprising:
a first component supported rotatably in relation to a second component,
a fixed seal element on the second component,
a rotatable seal element on the first component supported in sliding contact with the fixed seal element,
a bellows comprising an elastic annular channel having a U-shaped cross section, a radially inner wall portion having a first end and a radially outer wall portion having a second end and a rest configuration in which the first end is spaced from the second end by a first distance,
wherein the fixed seal element is connected to the radially inner wall portion of the bellows and the radially outer wall portion of the bellows is attached to the second component, and
wherein the bellows is compressed such that the first end is spaced from the second end by a second distance less than the first distance and such that the elastic bellows presses the fixed seal element against the rotatable seal element.
